(19) United States
(12) Patent Application Publication
(10) Pub. No.: US 2020/0074143 A1
(43) Pub. Date: Mar. 5, 2020

(54) Unmanned aerial device for smoke and fire detection and method to monitor occupants

(71) Applicants: Vipin Vangara, Bangalore (IN); Ravi Chandar Vangara, Bangalore (IN)

(72) Inventors: Vipin Vangara, Bangalore (IN); Ravi Chandar Vangara, Bangalore (IN)

(21) Appl. No.: 16/296,138

(22) Filed: Mar. 7, 2019

(30) Foreign Application Priority Data
Aug. 28, 2018 (IN) 201841032094

(51) Int. Cl. G06K 9/00; G08B 17/10; B64C 39/02; H04W 4/90

(52) U.S. Cl. CPC G06K 9/0063; G08B 17/10; B64C 2201/127; H04W 4/90; B64C 39/024

(57) ABSTRACT

Unmanned aerial device for smoke and fire detection and method to monitor occupants are provided. The unmanned aerial device which is operatively coupled with at least one electromagnetic device includes a plurality of sensors configured to sense at least one of smoke and fire and to sense a temperature of at least one of one or more users and one or more objects within the pre-defined area. The unmanned aerial device also includes an image capturing device configured to capture one or more images and to capture one or more attributes associated with the corresponding at least one of the one or more users and the one or more objects, a thermal image capturing device configured to detect occupancy of the smoke and fire by an infrared sensor within the pre-defined area and to generate one or more thermal images.

### CROSS-REFERENCE TO RELATED APPLICATION

This application claims the benefit of complete patent application having Patent Application No. 201841032094 filed on Aug. 28, 2018 in India.

### FIELD OF INVENTION

Embodiments of the present disclosure relate to smoke and fire detecting device, and more particularly to unmanned aerial device for smoke and fire detection and method monitor occupants.

### BACKGROUND

Smoke is defined as a collection of airborne particles which are suspended with carbon or other elements in air which is typically emitted when a material or an object is subjected to pyrolysis or combustion. To detect such smoke in a localised environment, smoke detecting devices are used.

In a conventional smoke detecting device, smoke is detected either by an optical method or a physical method. Further, the optical method works based on photoelectric effect which uses photodiodes to detect fire within the localised environment and hence detects the smoke. Moreover, the physical method is based on ionisation principle, wherein the conventional smoke detecting device based on the ionisation principle is integrated with a small amount of radioactive material to detect the smoke within the localised environment. However, such system cannot be relied on for determining occupants within the localised environment. Also, the conventional smoke detecting device can generate an alarm on detecting the smoke or the fire within the localised environment which limits in notifying an authority responsible for enabling an action upon detecting smoke or fire within the localised environment.

In comparison with the conventional smoke detecting device, a newer smoke detecting device includes a camera and multiple sensors for determining multiple factors within the localised environment, when the localised environment is producing smoke due to fire which can be generated for any reason. The newer smoke detecting device is designed to move around the localised environment for determining the multiple factors upon detecting smoke or fire within the localised environment. The camera captures the images or videos of the localised environment upon fire being generated. The newer smoke detecting device captures the occupants within the localised environment and can also detect a location of the captured occupants using the multiple sensors located within the smoke detecting device. However, the newer smoke detecting devise does not specify the type of occupants captured such as live, dead or sick. Also, the newer detecting device can capture a presence, or an absence of the occupants hence limited to capturing an exact number of occupants within the localised environment. Further, the camera of the newer smoke detecting device do not capture physical appearance or physical measures of the occupants within the localised environment. Also, at times with the increasing level of smoke, the newer smoke detecting device fails to capture the occupants and other parameters within the localised environment.

Hence, there is a need for an improved unmanned aerial device for smoke and fire detection and method to scan and stream occupants to address the aforementioned issues.

### BRIEF DESCRIPTION

In accordance with one embodiment of the disclosure, unmanned aerial device for smoke and fire detection is provided. The unmanned aerial device includes a plurality of sensors. The plurality of sensors is configured to sense at least one of smoke and fire within a pre-defined area. The plurality of sensors is also configured to sense a temperature of at least one of one or more users and one or more objects within the pre-defined area. The unmanned aerial device also includes an image capturing device operatively coupled with the plurality of sensors. The image capturing device is configured to capture one or more images of the at least one of the one of one or more objects and the one or more uses. The image capturing device is also configured to capture one or more attributes associated with the corresponding at least one of the one or more users and the one or more objects. The unmanned aerial device also includes a thermal image capturing device operatively coupled to the plurality of sensors. The thermal capturing device is configured to detect occupancy of the at least one of the smoke and the fire by an infrared sensor within the pre-defined area. The thermal capturing device is also configured to generate one or more thermal images associated with the one or more objects and the one or more users upon detecting smoke within the pre-defined area. The unmanned aerial device is operatively coupled to at least one electromagnetic device. The at least one electromagnetic device is configured to generate a magnetic field to hold the unmanned aerial device. The at least one electromagnetic device is also configured to demagnetise the magnetic field upon detecting the at least one of the smoke or the fire to enable an operation of the unmanned aerial device.

In accordance with another embodiment of the disclosure, a method for detecting smoke and fire is disclosed. The method includes sensing at least one of smoke and fire within a pre-defined area. The method also includes sensing a temperature of at least one of one or more users and one or more objects within the pre-defined area. The method also includes capturing one or more images of the at least one of the one of one or more objects and the one or more uses. The method also includes capturing one or more attributes associated with the corresponding at least one of the one or more users and the one or more objects. The method also includes detecting occupancy of the at least one of the smoke and the fire by an infrared sensor within the pre-defined area. The method also includes generating one or more thermal images associated with the at least one of the plurality of objects and the plurality of users upon detecting smoke within the pre-defined area.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF THE DRAWINGS

The disclosure will be described and explained with additional specificity and detail with the accompanying figures in which:

FIG. 1 is a block diagram representation of an unmanned aerial device for smoke and fire detection in accordance with an embodiment of the present disclosure;

FIG. 2 is a schematic representation of an exemplary embodiment of a drone device for smoke and fire detection of FIG. 1 in accordance with an embodiment of the present disclosure;

FIG. 3 is a schematic representation of another exemplary embodiment of the drone device for smoke and fire detection of FIG. 1 in accordance with an embodiment of the present disclosure; and

FIG. 4 is a flow chart representing steps involved in a method for detecting smoke and fire in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or sub-systems or elements or structures or components preceded by “comprises . . . a” does not, without more constraints, preclude the existence of other devices, sub-systems, elements, structures, components, additional devices, additional sub-systems, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

Embodiments of the present disclosure relate to an unmanned aerial device for smoke and fire detection and method monitor occupants are provided. The unmanned aerial device includes a plurality of sensors. The plurality of sensors is configured to sense at least one of smoke and fire within a pre-defined area. The plurality of sensors is also configured to sense a temperature of at least one of one or more users and one or more objects within the pre-defined area. The unmanned aerial device also includes an image capturing device operatively coupled with the plurality of sensors. The image capturing device is configured to capture one or more images of the at least one of the one of one or more objects and the one or more uses. The image capturing device is also configured to capture one or more attributes associated with the corresponding at least one of the one or more users and the one or more objects. The unmanned aerial device also includes a thermal image capturing device operatively coupled to the plurality of sensors. The thermal capturing device is configured to detect occupancy of the at least one of the smoke and fire by an infrared sensor within the pre-defined area. The thermal capturing device is also configured to generate one or more thermal images associated with the one or more objects and the one or more users upon detecting smoke within the pre-defined area. The unmanned aerial device is operatively coupled to at least one electromagnetic device. The at least one electromagnetic device is configured to generate a magnetic field to hold the unmanned aerial device. The at least one electromagnetic device is also configured to demagnetise the magnetic field upon detecting the at least one of the smoke or the fire to enable an operation of the unmanned aerial device.

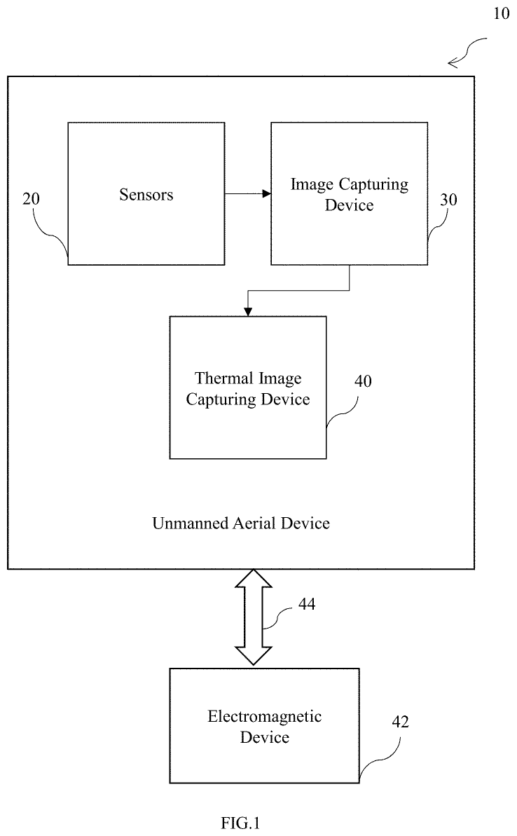

FIG. 1 is a block diagram representation of an unmanned aerial device (10) for smoke and fire detection in accordance with an embodiment of the present disclosure. As used herein, the term ‘unmanned aerial device’ (10) is defined as an aircraft without having a human pilot on board. The unmanned aerial device (10) includes a plurality of sensors (20). The plurality of sensors (20) is configured to sense at least one of smoke and fire within a pre-defined area. In one embodiment, the plurality of sensors (20) may include at least one of an infrared (IR) sensor, a smoke sensor, a flame sensor and a global positioning system sensor. In one exemplary embodiment, the plurality of sensors (20) may detect the fire first within the pre-defined area and upon detecting the fire, the smoke generated by the fire may be detected. In another embodiment, the pre-defined area may be attacked with the smoke without the fire being generated. In such a situation, the plurality of sensors (20) may detect the smoke within the pre-defined area.

The plurality of sensors (20) is also configured to sense a temperature of at least one of one or more users and one or more objects within the pre-defined area. In one embodiment, the one or more users may correspond to one or more occupants within the pre-defined area. In another embodiment, the one or more objects may correspond to one or more articles or one or more items which may be located within the pre-defined area. In one exemplary embodiment, the pre-defined area may correspond to a small area in a building. In another embodiment, the pre-defined area may be a multi storeyed building. In one specific embodiment, the unmanned aerial device (10) may travel near the one or more users or the one or more objects to sense the temperature.

In one exemplary embodiment, the unmanned aerial device (10) may include a processor (not shown in FIG. 1) operatively coupled to the plurality of sensors (20). The processor may be configured to process a sensed parameter associated with the smoke upon detecting the fire within the pre-defined area. Furthermore, the processor may also be configured to processes the temperature of at least one of the one or more users and the one or more objects within the pre-defined area.

The unmanned aerial device (10) also includes an image capturing device (30) operatively coupled with the plurality of sensors (20). As used herein, the term ‘image capturing device’ (30) is defined as a device used to obtain one or more digital images with the help of a vision sensor. The image capturing device (30) is configured to capture one or more images of the at least one of the one of one or more objects and the one or more uses. In one embodiment, the image capturing device (30) may be a camera. In one specific embodiment, the image capturing device (30) may be a three-dimensional (3D) camera and an infrared (IR) camera. In one exemplary embodiment, the one or more images associated with the at least one of the one of one or more objects and the one or more uses may be further processed by the processor.

Furthermore, the image capturing device (30) is also configured to capture one or more attributes associated with the corresponding at least one of the one or more users and the one or more objects. In one embodiment, the one or more attributes associated with the corresponding one or more users may include at least one of a height, an age, a gender, temperature and emotion of the corresponding one or more users. In another embodiment, the one or more attributes associated with the corresponding one or more objects may include at least one of a dimension, a location and physical condition of the corresponding one or more objects. In one exemplary embodiment, the one or more attributes associated with the at least one of the one or more users and the one or more objects may be processed by the processor.

The unmanned aerial device (10) also includes a thermal image capturing device (40) operatively coupled to the plurality of sensors (30). As used herein, the term ‘thermal image capturing’ (40) a device with a heat sensor which is capable of detecting temperature differences of the one or more users and the one or more objects. The thermal image capturing device (40) is configured to detect occupancy of the at least one of the smoke and fire by an infrared sensor within the pre-defined area. In one embodiment, the infrared energy may correspond to heat produced by the one or more objects or the one or more users. Further, the thermal image capturing device (40) collects infrared energy from the one or more users or the one or objects.

The thermal image capturing device (40) is also configured to generate one or more thermal images associated with the one or more objects and the one or more users upon detecting smoke or fire within the pre-defined area. In one embodiment, the one or more thermal images may be generated based on the infrared energy collected from the corresponding at least one of the one or more users and the one or objects. In one embodiment, the thermal image capturing device (40) may be configured to generate one or more thermal videos associated with the one or more objects and the one or more users upon detecting smoke or fire within the pre-defined area which may be streamed to a central command centre.

In one exemplary embodiment, the one or more thermal images associated with the one or more objects and the one or more users upon detecting the smoke within the pre-defined area may be processed by the processor to determine one or more situations of the corresponding at least one of the one or more users and the one or more objects. In one embodiment, the one or more situations associated with the one or more users may correspond to the one or more users being alive, dead or sick within the pre-defined area upon detecting the smoke or the fire.

In one specific embodiment, the one or more thermal images upon being processed by the processor may determine an exact number of the one or more users present within the pre-defined area. In such embodiment, the height, the age, the gender, the temperature and the emotion of the corresponding one or more users may be determined based on the one or more thermal images which may be captured by the thermal image capturing device (40).

Furthermore, in one specific embodiment, the processer may be further configured to generate an alert notification upon detecting an emergency situation within the pre-defined area. In such embodiment, an alert device (not shown in FIG. 1) may be operatively coupled to the processor. The alert device may be configured to generate an alert to bring into notice the emergency situation at the pre-defined area.

Furthermore, the unmanned aerial device (10) is operatively coupled to at least one electromagnetic device (42). In one embodiment, the at least one electromagnetic device (42) may be operatively coupled to a ceiling or a wall of the pre-defined area. The at least one electromagnetic device (42) is configured to generate a magnetic field (44) to hold the unmanned aerial device (10). In such embodiment, the unmanned aerial device (10) may be coupled with an electromagnetic material (not shown in FIG. 1) because of which the at least one electromagnetic device may hold the unmanned aerial device (10) at the ceiling or the wall of the pre-defined area.

Furthermore, the at least one electromagnetic device (42) 81so isis also configured to demagnetise the magnetic field (44) upon detecting the at least one of the smoke or the fire to enable an operation of the unmanned aerial device (10). More specifically, upon detecting the smoke or the fire within the pre-defined area, the at least one electromagnetic device (42) may receive a notification by the processer based on which the at least one electromagnetic device (42) may start to demagnetise the generated magnetic field between the unmanned aerial device (10) and the at least one electromagnetic device (42). Further, on being demagnetised, the unmanned aerial device (10) may be enabled to operate. In such an embodiment, the at least one electromagnetic device (42) may also be configured to charge the unmanned aerial device (10) which may be further utilised for the operation of the same.

In another exemplary embodiment, the unmanned aerial device (10) may be operatively coupled to an already existing smoke detecting device (not shown in FIG. 1) which may include a charging port configured to charge the unmanned aerial device (10) and an electromagnet to hold the unmanned aerial device (10) electromagnetically.

In one specific embodiment, the unmanned aerial device (10) may include a transmitting device (not shown in FIG. 1). The transmitting device may be configured to transmit the at least one of the temperature of at least one of one or more users and one or more objects within the pre-defined area, the one or more images, the one or more attributes, the infrared energy and the one or more thermal images, one or more thermal videos to a computing device through a wireless communication medium in real time. In such embodiment, the wireless communication medium may operate through a wireless communication medium such as a cellular network which may include 2G, 3G, 4G, 5G, LTE, WiFi, BLUETOOTH, ZIGBEE, Low Power WAN and the like. In such another embodiment, the computing device may locate the unmanned aerial device (10) through the global positioning system (GPS) sensor located within the unmanned aerial device.

In one embodiment, the alert notification may be accessible by a supervisor of the pre-defined area to enable the supervisor to take respective measures. In another embodiment, the alert notification may be transmitted to at least one of a registered mobile number, an administrator and a fire fighting company automatically by the processor upon detection of the smoke or the fire within the pre-defined area. in such embodiment, the data processed by the processor may be in a form of at least one of an image, a live video feed, a statistical data or the like. In such embodiment, the notification may enable the at least one electromagnetic device (42) to demagnetise the magnetic field (44) and may enable the unmanned aerial device (10) to sense, scan and stream live visual of the pre-defined area to a command centre upon using a unique identification (ID) number and a location which may be associated with the unmanned aerial drone (10).

In one exemplary embodiment, data which is sensed, captured and accessed by the unmanned aerial device (10) may be stored on a remote storage such as a cloud storage which may be retrieved for further references. In one embodiment, the data may be coupled with artificial intelligence which may be used to determine severity of any accident at a central command centre.

In one specific embodiment, the unmanned aerial device (10) may further include a charging device (not shown in FIG. 1) which may be operatively coupled to the at least one electromagnetic device. The charging device may be configured to charge the unmanned aerial device to enable the operation upon sensing the smoke. In one exemplary embodiment, the unmanned aerial device (10) may be equipped with artificial intelligence technique which may be used to determine the accuracy of one or more visuals associated with the at least one of the smoke and the fire within the pre-defined area to indicate the complexity of the fire or the smoke.

In operation, the pre-defined area may be caught with the fire or the smoke which is detected by the plurality of sensors (20) placed within the unmanned aerial device (10). Further on detecting the smoke or the fire, the at least one electromagnetic device demagnetises the unmanned aerial device (10) and enables the unmanned aerial device (10) to operate. Consequently, the plurality of sensors (20) will sense the temperature of the at least one of one or more users and one or more objects within the pre-defined area. The image capturing device (30) which is operatively coupled to the plurality of sensors (20). The image capturing device (30) captures the one or more 3D images of the at least one of the one of one or more objects and the one or more uses. The image capturing device (30) also captures the one or more attributes associated with the corresponding at least one of the one or more users and the one or more objects. Further, the one or more images and the one or more attributes is processed by the processor. Also, the thermal image capturing device (40) detects the infrared energy within the pre-defined area. The thermal image capturing device (40) generates the one or more thermal images associated with the one or more objects and the one or more users. Furthermore, the infrared energy and the one or more thermal images are processed by the processor and the alert notification is generated by the processor which is transmitted to the alert device. The alert device further generates the alert upon detecting the emergency situation within the pre-defined area. The processor also transmits the alert notification to the computing device which is accessible by the supervisor of the pre-defined area to enable the supervisor to take respective measures. In addition, the supervisor detects the location of the unmanned aerial device (10) through the GPS sensor.

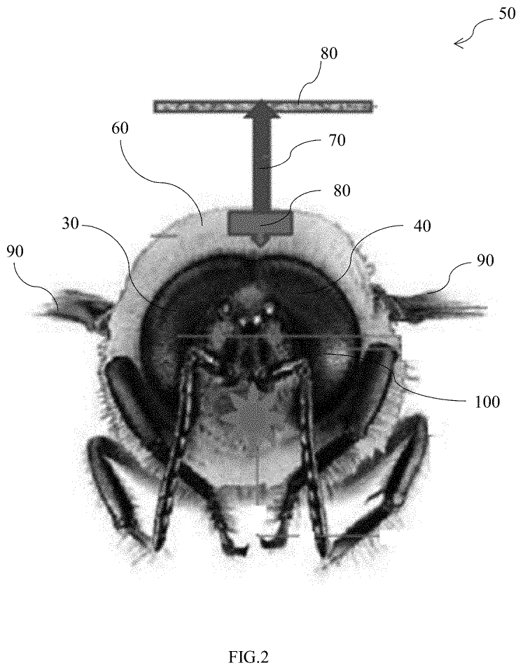

FIG. 2 is a schematic representation of an exemplary embodiment of a drone device (50) for smoke detection of FIG. 1 in accordance with an embodiment of the present disclosure. The drone is in the form of a bee forming a bee drone. The plurality of sensors (not shown in FIG. 2) is operatively coupled to a head portion (60) of the bee drone (50) configured to sense the smoke upon detecting the fire within the pre-defined area. Further on detecting the smoke, the bee drone (50) gets demagnetised from the at least one electromagnetic device (70) which is attached to the ceiling (80) of the pre-defined area and enables the operation of the bee drone (50). In addition, the bee drone (50) is operatively coupled with two wings (90), wherein each of the two wings (90) is placed on either side of a body of the bee drone (50) which is configured to enable the bee drone (50) to move around the pre-defined area in air.

Furthermore, the plurality of sensors senses the temperature of at least one of the one or more users and the one or more objects within the pre-defined area. In addition, the image capturing device (30) and the thermal image capturing device (40) are fabricated on either of eyes (100) of the bee drone (50) respectively. The image capturing device (30) capture the one or more images and the one or more attributes associated with the corresponding at least one of the one or more users and the one or more objects respectively. Also, the thermal image capturing device (40) detects the infrared energy generates the one or more thermal images associated with the one or more objects and the one or more users upon detecting smoke within the pre-defined area.

In addition, data captured by the bee drone (50) is processed and transmitted to the computing device by the processor through the wireless communication means in real time.

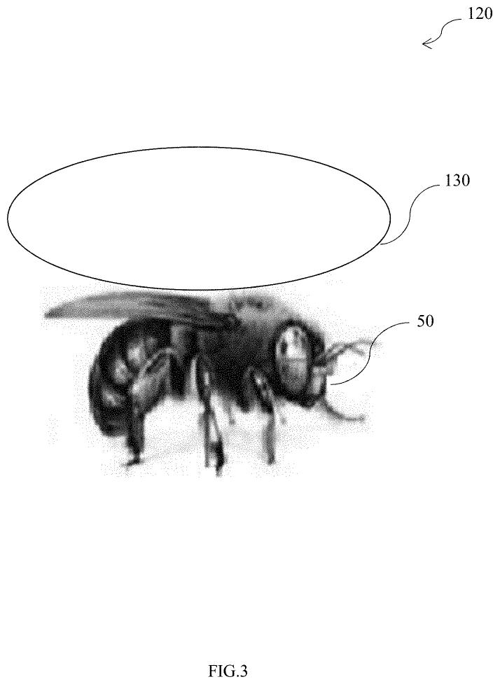

FIG. 3 is a schematic representation (120) of another exemplary embodiment of the drone device (50) for smoke detection of FIG. 1 in accordance with an embodiment of the present disclosure. The bee drone (50) is operatively coupled to an ADT smoke detecting device (130) which is configured to generate magnetism in order to hold the bee drone (50) attached to the ADT smoke detector (130). In addition, the ADT smoke detector (130) includes a charging device (not shown in FIG. 3) which is configured to charge the bee drone (50) to enable the operation upon smoke detection.

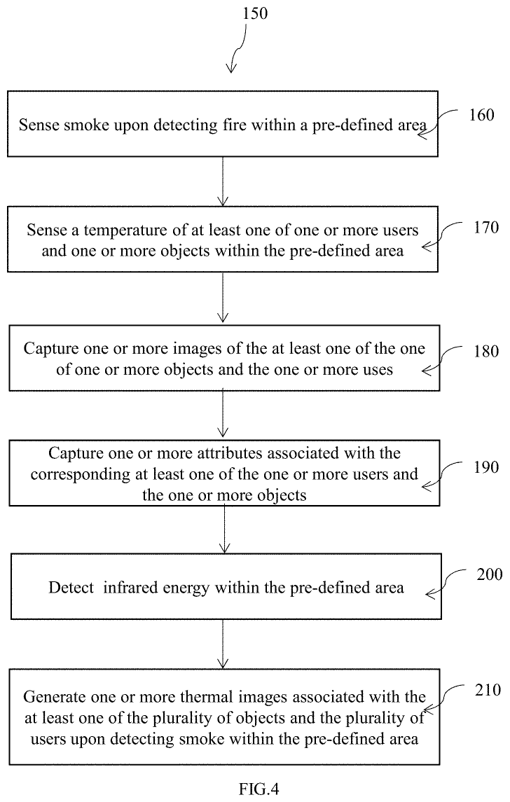

FIG. 4 is a flow chart representing steps involved in a method (150) for detecting smoke in accordance with an embodiment of the present disclosure. The method (150) includes sensing smoke upon detecting fire within a pre-defined area in step 160. In one embodiment, sensing the smoke upon detecting the fire may include sensing the smoke upon detecting the fire by a plurality of sensors.

The method (150) also includes sensing a temperature of at least one of one or more users and one or more objects within the pre-defined area in step 170. In one embodiment, sensing the temperature of at least one of one or more users and one or more objects.

Furthermore, the method (150) also includes capturing one or more images of the at least one of the one of one or more objects and the one or more uses in step 180. In one embodiment, capturing the one or more images may include capturing the one or more images by an image capturing device. In one exemplary embodiment, capturing the one or more images may include capturing one or more three-dimensional images associated with the at least one of the one of one or more objects and the one or more uses.

The method (150) also includes capturing one or more attributes associated with the corresponding at least one of the one or more users and the one or more objects in step 190. In one embodiment, capturing the one or more attributes may include capturing the one or more attributes by the image capturing device. In one exemplary embodiment, capturing the one or more attributes associated with the one or more users may include capturing at least one of a height, an age, a gender and emotion of the corresponding one or more users. In another embodiment, capturing the one or more attributes associated with the one or more objects may include capturing at least one of a dimension, a location and physical condition of the corresponding one or more objects.

The method (150) also includes detecting infrared energy within the pre-defined area in step 200. In one embodiment, detecting the infrared energy may include detecting the infrared energy by a thermal image capturing device.

Furthermore, the method (150) includes generating one or more thermal images associated with the at least one of the plurality of objects and the plurality of users upon detecting smoke within the pre-defined area in step 210. In one embodiment, generating the one or more thermal images may include generating the one or more thermal images by the thermal image capturing device.

In one specific embodiment, the method (150) may further include generating an alert notification upon detecting an emergency situation within the pre-defined area. In such embodiment, generating the alert notification may include generating the notification by an alert device, and demagnetise the unmanned aerial device to sense, scan and stream one or more visuals associated with the pre-defined area to the command centre with the unique identification number and the location.

Various embodiments of the unmanned aerial device for smoke detection and a method to operate the same enable the unmanned aerial device to determine the one or more users within the pre-defined area automatically without an intervention of any third person.

In addition, the unmanned aerial device is designed in such a way that the unmanned aerial device can capture and process the one or more attributes associated with the one or more users and the one or more objects. Thereby determining the physical appearance or the physical measures of the one or more users hence enabling a dynamic detection of the presence of the one or more users involved within the pre-defined area. Furthermore, the unmanned aerial address is enabled to scan the pre-defined area autonomously.

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, order of processes described herein may be changed and are not limited to the manner described herein. Moreover, the actions of any flow diagram need not be implemented in the order shown; nor do all of the acts need to be necessarily performed. Also, those acts that are not dependent on other acts may be performed in parallel with the other acts. The scope of embodiments is by no means limited by these specific examples.

We claim:

1. An unmanned aerial device (10) comprising:
a plurality of sensors (20) configured to:
sense at least one of smoke and fire within a pre-defined area;
sense a temperature of at least one of one or more users and one or more objects within the pre-defined area;
an image capturing device (30) operatively coupled with the plurality of sensors (20), and configured to:
capture one or more images of the at least one of the one of one or more objects and the one or more uses;
capture one or more attributes associated with the corresponding at least one of the one or more users and the one or more objects;
a thermal image capturing device (40) operatively coupled to the plurality of sensors (20), and configured to:
detect occupancy of the at least one of the smoke and fire by an infrared sensor within the pre-defined area;
generate one or more thermal images associated with the one or more objects and the one or more users upon detecting smoke within the pre-defined area,
wherein, the unmanned aerial device (10) is operatively coupled to at least one electromagnetic device, wherein the electromagnetic device is configured to:
generate a magnetic field to hold the unmanned aerial device (10); and
demagnetise the magnetic field upon detecting the at least one of the smoke and the fire to enable an operation of the unmanned aerial device (10).

2. The unmanned aerial device (10) as claimed in claim 1, wherein the unmanned aerial device (10) corresponds to a drone.

3. The unmanned aerial device (10) as claimed in claim 1, wherein the plurality of sensors (20) comprises at least one of an infrared (IR) sensor, a smoke sensor, a flame sensor and a global positioning system sensor.

4. The unmanned aerial device (10) as claimed in claim 1, wherein the image capturing device (30) corresponds to a three-dimensional (3D) camera.

5. The unmanned aerial device (10) as claimed in claim 1, wherein the one or more attributes associated with the one or more users comprises at least one of a height, an age, a gender, temperature and emotion of the corresponding one or more users and the one or more attributes associated with the one or more objects comprises at least one of a dimension, a location and physical condition of the corresponding one or more objects.

6. The unmanned aerial device (10) as claimed in claim 1, further comprising a processing subsystem operatively coupled to the plurality of sensors (20), and configured to:
process a sensed parameter associated with the smoke upon detecting the fire within the pre-defined area;
processes the temperature of at least one of the one or more users and the one or more objects within the pre-defined area;
process the one or more images of the at least one of the one of one or more objects and the one or more uses;
processing the one or more attributes associated with the at least one of the one or more users and the one or more objects;
process the one or more thermal images associated with the one or more objects and the one or more users upon detecting the smoke within the pre-defined area; and
generate an alert notification upon detecting an emergency situation within the pre-defined area.

7. A method (150) comprising:
sensing, by a plurality of sensors, at least one of smoke and fire within a pre-defined area; (160)
sensing, by the plurality of sensors, a temperature of at least one of one or more users and one or more objects within the pre-defined area; (170)
capturing, by an image capturing device, one or more images of the at least one of the one of one or more objects and the one or more uses; (180)
capturing, by the image capturing device, one or more attributes associated with the corresponding at least one of the one or more users and the one or more objects; (190)
detecting, by a thermal image capturing device, occupancy of the at least one of the smoke and the fire by an infrared sensor within the pre-defined area; and (200)
generating, by the thermal image capturing device, one or more thermal images associated with the at least one of the plurality of objects and the plurality of users upon detecting smoke within the pre-defined area. (210)

8. The method (150) as claimed in claim 7, wherein sensing at least one of smoke and fire within a pre-defined area comprises demagnetising, by at least one electromagnetic device, magnetic field upon sensing the at least one of smoke and fire within the pre-defined area.

9. The method (150) as claimed in claim 7, wherein capturing the one or more attributes associated with the corresponding at least one of the one or more users and the one or more objects comprises capturing at least one of a height, an age, a gender and emotion of the corresponding one or more users and capturing the one or more attributes associated with the one or more objects comprises at least one of a dimension, a location and physical condition of the corresponding one or more objects.

10. The method (150) as claimed in claim 7, further comprising generating an alert notification upon detecting an emergency situation within the pre-defined area.
